(19) United States
(12) Patent Application Publication
(10) Pub. No.: US 2012/0047869 A1
(43) Pub. Date: Mar. 1, 2012

(54) WEEDER RAKE SYSTEMS

(76) Inventor: David Knoblock, SR., Apache Junction, AZ (US)

(21) Appl. No.: 13/185,337

(22) Filed: Jul. 18, 2011

Related U.S. Application Data
(60) Provisional application No. 61/377,957, filed on Aug. 29, 2010.

(51) Int. Cl. A01D 11/06

(52) U.S. Cl. 56/400.05

(57) ABSTRACT

Weeder rake systems may comprise a multifunctional gardening tool for both removing and clearing weeds and debris. A weeder rake generally comprises a long cylindrical handle comprising a rake head on one end and a weeder on the other end. The rake head comprises a fan-like profile comprising a plurality of raking tines for effectively collecting and clearing debris. The weeder a weed cutter head comprising a cutting blade which is attachable via a blade fastener. The weed cutter head and the cutting blade form a trapezoid-shaped member comprising and open inner volume. The cutting blade is preferably serrated and may be used for cutting and removing weeds and vegetation.

### CROSS-REFERENCE TO RELATED APPLICATION

The present application is related to and claims priority from prior provisional application Ser. No. 61/377,957, filed Aug. 29, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### FIELD OF THE INVENTION

The present invention relates generally to the field of garden tools and more specifically relates to a multifunctional garden tool comprising a rake and a weeder.

### DESCRIPTION OF THE RELATED ART

A rake is a common tool used to “scrape together,” to “heap up” various debris as typically found in lawns and gardens. The tool is an agricultural and horticultural implement consisting traditionally of a toothed bar fixed transversely to a handle, and used to collect leaves, hay, grass, etc., and, in gardening, for loosening the soil, light weeding, leveling, and removing dead grass from lawns. Modern hand-rakes may have steel, plastic, or bamboo teeth or tines, or optionally be made from wood or iron. The handle is often constructed of wood or metal. Some rakes are two-sided and made with dull blades in the shapes of slight crescents, used for removing dead grass from lawns. Since rakes are single-purpose tools, they may not be able to perform a plurality of tasks in an efficient, cost-effective manner.

Consequently, if a yard worker wishes to cut and remove weeds or other plants, multiple tools are required. This may result in the carrying of heavy and cumbersome long-handled tools for accomplishing relatively mundane gardening tasks. An elderly person who wishes to maintain his or her own yard may become worn out from carrying the tools, or might unnecessarily become injured due to constantly bending down to switch between tools. A more effective solution is needed.

Various attempts have been made to solve the above-mentioned problems such as those found in U.S. Pat. Nos. 4,212,150 to Frank M. Dmochowski; 4,478,033 to Dale R. Konyn et al; and U.S. Pat. No. 4,483,133 to James M. Hanly et al. This prior art is representative of multifunctional rakes. None of the above inventions and patents, taken either singly or in combination, is seen to describe the invention as claimed.

Ideally, a multifunctional rake and weeder tool should require and, yet, would operate reliably and be manufactured at a modest expense. Thus, a need exists for reliable weeder rake systems to provide a multi-purpose gardening implement comprising both a rake and a weeder and to avoid the above-mentioned problems.

### BRIEF SUMMARY OF THE INVENTION

In view of the foregoing disadvantages inherent in the known multifunctional rake art, the present invention provides a novel weeder rake system. The general purpose of the present invention, which will be described subsequently in greater detail is to provide a gardening tool comprising a long handle comprising a rake at one end, and a weeder comprising a cutting edge at the other end.

The present invention holds significant improvements and serves as a weeder rake system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, weeder rake systems, constructed and operative according to the teachings of the present invention.

FIG. 1 shows a perspective view illustrating a weeder of a weeder rake system in an in-use condition according to an embodiment of the present invention.

FIG. 2 is a perspective view illustrating the weeder rake according to an embodiment of the present invention of FIG. 1.

FIG. 3 is an exploded view illustrating the weeder rake according to an embodiment of the present invention of FIG. 1.

FIG. 4A is a rear perspective view illustrating a weeder cutter head comprising a serrated blade according to an embodiment of the present invention of FIG. 1.

FIG. 4B is a rear perspective view illustrating a rake head comprising a plurality of raking tines according to an embodiment of the present invention of FIG. 1.

FIG. 5 is a front perspective view illustrating the rake head of the weeder rake system in an in-use condition secured according to an embodiment of the present invention of FIG. 1.

FIG. 6 is a flowchart illustrating a method of use according to an embodiment of the present invention of FIGS. 1-5.

The various embodiments of the present invention will hereinafter be described in conjunction with the appended drawings, wherein like designations denote like elements.

### DETAILED DESCRIPTION

As discussed above, embodiments of the present invention relate to a multi-purpose gardening and yard work tool and more particularly to a gardening tool comprising both a weeder and a rake as used to improve the efficiency and ease in removing and clearing weeds and other unwanted plants from the ground. The present invention is designed to provide a user with both a weeder and a rake in a single tool.

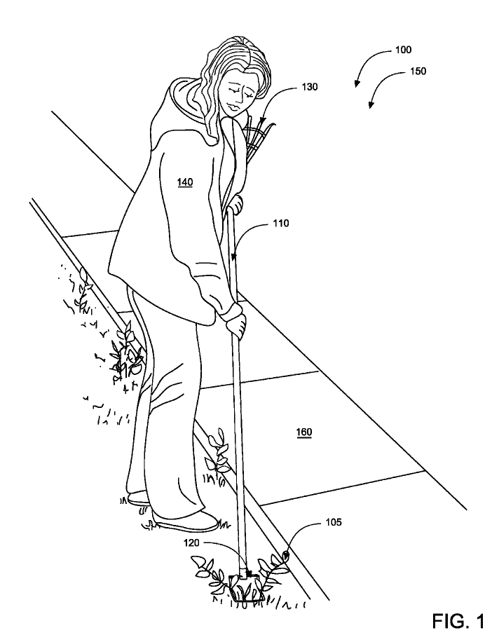

Referring to the drawings by numerals of reference there is shown in FIG. 1, weeder rake systems 100 in in-use condition 150 according to an embodiment of the present invention. As shown, weeder rake systems 100 may generally comprise handle 110, weed cutter head 120, and rake head 130. Handle 110 may comprise a long cylindrical rod designed to be comfortably gripped and manipulated by user 140. Weed cutter head 120 may be attached to a proximal end of handle 110 and rake head may be attached to a distal end of handle 110. As shown in FIG. 1, user 140 may use weed cutter head 120 of weeder rake systems 100 to easily cut and remove weeds 105 accumulating near sidewalk 160.

In continuing to refer to FIG. 1, handle 110 may comprise finished wood. The finished wood provides a stiff and sturdy cylindrical rod for supporting weed cutter head 120 and rake head 130. Further, handle 110 may alternatively comprise durable, weather-resistant plastic. In one embodiment of the present invention, weed cutter head 120, rake head 130, and handle 110 may comprise a length of approximately 70 inches when it is fully assembled. However it should be appreciated that in alternative embodiments, handle 110 may comprise a shorter or longer length which may be better suited for alternative applications.

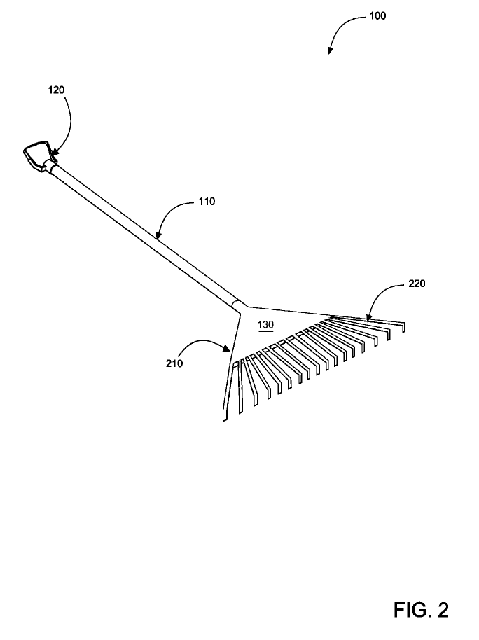

Referring now to FIG. 2, illustrating a perspective view of weeder rake systems 100 according to a preferred embodiment of the present invention. As shown, rake head 130 may comprise fan-shape profile 210 projecting outwardly from handle 110. Rake head 130 may further comprise a plurality of raking tines 220. Each individual raking tine 220 may comprise a tip which is bent downward. As a consequence of the bent profile, raking tines 220 may effectively clear weeds and other debris that may be intermingled within grass and other vegetation. Raking tines 220 may comprise a ferrous material that is slightly pliable. Because of their slightly pliable nature, raking tines 220 may bias. Preferably, rake head 130 comprises a durable, weather-proof plastic or ferrous material to ensure continued use of weeder rake systems 100.

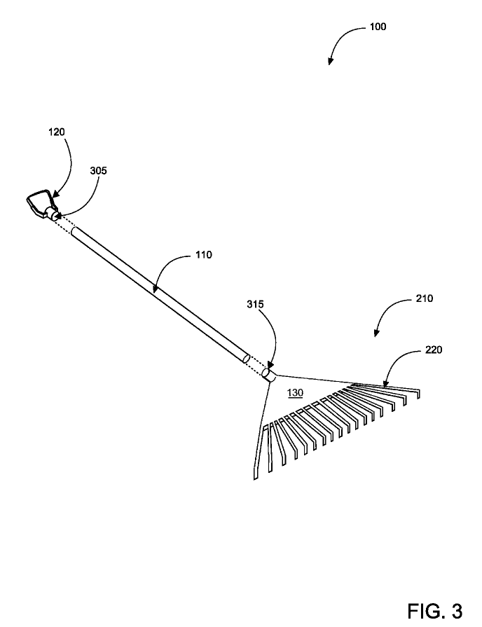

In referring now to FIG. 3, illustrating an exploded view of weeder rake systems 100. As shown, weed cutter head 120 may comprise weeder handle inserter 305 wherein weeder handle inserter 305 comprises a friction-fitting cap. The friction-fitting cap comprises an inner volume to frictionally receive the proximal side of handle 110. Proper insertion should result in air suction thereby forming a secure relationship between handle 110 and weeder handle inserter 305 of weed cutter head 120.

In continuing to refer to FIG. 3, rake head 130 may comprise rake handle receiver 315. As shown, handle 110 may be frictionally inserted into rake handle receiver 315 thereby securing handle 110 to rake head 130. Preferably, rake handle receiver 315 comprises a durable, weather-resistant plastic material. However, in alternative embodiments rake head 130 and rake handle receiver 315 may comprise a ferrous material.

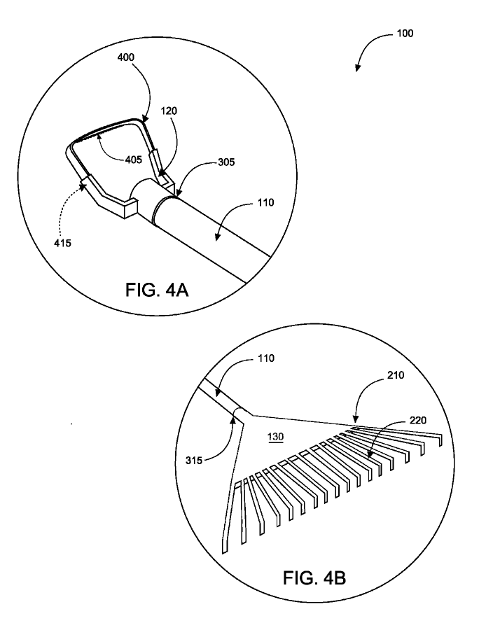

Referring now to FIG. 4A, illustrating a close-up perspective view of weed cutter head 120 of weeder rake systems 100 according to an embodiment of the present invention. Weed cutter head 120 may comprise cutting blade 400 having a substantially “C” shaped profile. Preferably, cutting blade 400 comprises steel and is attachable to weed cutter head 120 via blade fastener 415. When cutting blade 400 is fastened to weed cutter head 120, the weeder may comprise a trapezoid-shaped member comprising an open inner volume and having at least one cutting edge for cutting weeds 105.

According to one embodiment of the present invention, cutting blade 400 comprises serrated edge 405. It should be appreciated that serrated edge 405 facilitates cutting and removing weeds 105 and other vegetation. In use, user 140 need only apply a minimal amount of force using handle 110 to cut weeds 105 and other vegetation that might prove difficult to cut and remove without serrated edge 405.

In still referring to FIG. 4A, weed cutter head 120 may comprise an angle of approximately 70 degrees relative to handle 110. The 70 degree angle of weed cutter head 120 enables user 140 to manipulate handle 110 of weeder rake systems 100 to cut and remove weeds 105 in an improved energy efficient manner. It should further be noted that weed cutter head 120 comprises a frame for retaining cutting blade 400.

It should further be appreciated that weeder rake systems 100 may be hung vertically on a nail from weed cutter head 120. Furthermore, because cutting blade 400 comprises serrated edge 405, the serrations provide a more stable hanging surface which may minimize accidental falling of weeder rake systems 100. The vertical hanging feature of weeder rake systems 100 provides a space saving function during storage.

In referring now to FIG. 4B, illustrating a close-up perspective view of rake head 130 of weeder rake systems 100 according to an embodiment of the present invention. As illustrated, rake head 130 comprises fan-shape profile 210 which may project outwardly from handle 110. Rake head 130 may further comprise a plurality of raking tines 220. As shown, rake head 130 may be securely connected to handle 110 via rake handle receiver 315.

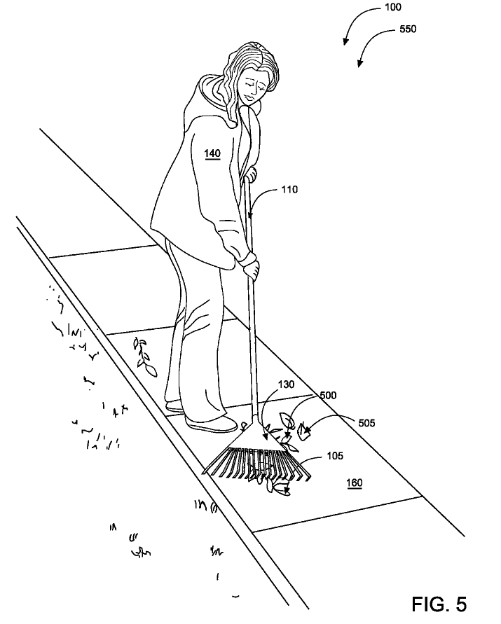

Referring now to FIG. 5, showing weeder rake systems 100 an in-use condition 550 according to an embodiment of the present invention. As shown, user 140 need only turn weeder rake systems 100 upside-down to use rake head 130 for collecting and clearing weeds 105, debris 500, and leaves 505. User 140 may utilize weeder rake systems 100 as a single gardening implement which may minimize the need for carrying multiple tools to accomplish the task of removing and clearing weeds 105 and other vegetation from the ground.

Weeder rake systems 100 according to an embodiment of the present invention of FIGS. 1-5 may comprise kit 540. Kit 540 may comprise the following parts: at least one handle 110; at least one weed cutter head 120 comprising at least one weeder handle inserter 305, at least one cutting blade 400, and at least one blade fastener 415; at least one rake head 130 comprising a plurality of raking tines 220 and at least one rake handle receiver 315; and at least one set of user instructions. Weeder rake systems 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

It should be appreciated that weeder rake systems 100 may be manufactured using lightweight, durable, and weather resistant materials thereby providing user 140 with a non-heavy, multifunctional gardening apparatus that may pass the test time. Furthermore, weeder rake systems 100 may comprise indicia or logos adorned to the various surfaces of the components. In addition, weed cutter head 120 and rake head 130 may comprise various colors for aesthetic purposes. In an alternative embodiment of the present invention, handle 110 may comprise a substantially shorter length thereby providing user 140 with a one-handed multifunctional garden tool for smaller tasks.

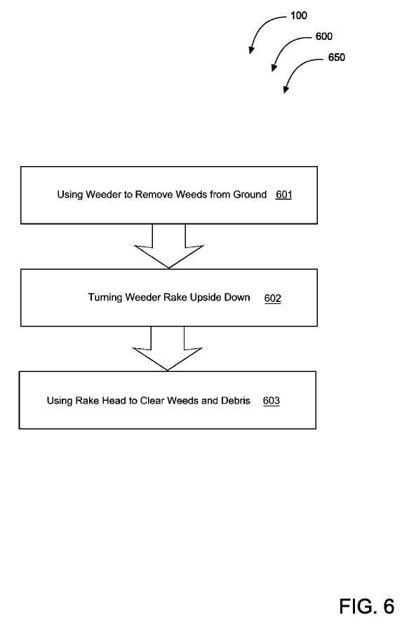

FIG. 6 shows flowchart 650 illustrating method of use 600 of weeder rake systems 100 according to a preferred embodiment of the present invention of FIGS. 1-5. Method of use 600 may comprise the steps of: step one 601 using weed cutter head 120 of weeder rake systems 100 to remove weeds 105 from ground; step two 602 turning weeder rake systems 100 upside down; and step three 603 using rake head 130 to clear weeds 105, debris 500, and leaves 505.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1) A weeder rake system comprising;
a) at least one cylindrical rod;
b) at least one weed cutter head;
c) at least one “C” shaped cutting blade; and
d) at least one rake head;
e) wherein said cylindrical rod comprises a distal end and a proximal end;
f) wherein said weed cutter head comprises a blade fastener for securing said at least one cutting blade to said weed cutter head;
g) wherein said weed cutter head and said cutting blade form together to create a trapezoid-shaped member comprising an open inner volume having said at least one cutting blade for cutting weeds;
h) wherein said weed cutter head comprises a rod inserter such that said weed cutter head is securely attachable to said proximal end of said cylindrical rod;
i) wherein said rake head comprises a rod receiver such that said rake head is securely attachable to said distal end of said cylindrical rod; and
j) wherein said weeder rake system provides a multifunctional gardening tool for removing weeds from the ground via said weeder and for clearing weeds and other debris via said rake head.

2) The weeder rake system of claim 1, wherein said cylindrical rod comprises a handle.

3) The weeder rake system of claim 2, wherein said handle comprises finished wood whereby the handle is made stiffer.

4) The weeder rake system of claim 1, wherein said weeder rake system comprises a length of approximately 45 inches.

5) The weeder rake system of claim 1, wherein said weed cutter head comprises an angle of approximately 70 degrees relative to said cylindrical rod.

6) The weeder rake system of claim 1, wherein said weed cutter head comprises weather durable and impact-resistant plastic material.

7) The weeder rake system of claim 1, wherein said weed cutter head comprises a ferrous material.

8) The weeder rake system of claim 1, wherein said trapezoid-shaped member comprises a frame mechanically containing said “C” shaped cutting blade.

9) The weeder rake system of claim 1, wherein said rod inserter of said weed cutter head comprises a friction-fitting cap that further comprises an inner volume to frictionally receive the proximal side of said handle wherein insertion results in air suction thereby forming a secure relationship between said handle and weeder handle inserter.

10) The weeder rake system of claim 1, wherein said trapezoidal member of said weed cutter head comprises a hanger having at least one “C” shaped serrated edge for stably vertically hanging said weeder rake system.

11) The weeder rake system of claim 1, wherein said cutting blade comprises steel.

12) The weeder rake system of claim 11, wherein said cutting blade comprises the at least one “C” shaped serrated edge for stably vertically hanging said weeder rake system.

13) The weeder rake system of claim 1, wherein said rake head comprises a fan profile.

14) The weeder rake system of claim 1, wherein said rake head comprises a plurality of tines.

15) The weeder rake system of claim 14, wherein said plurality of tines of said rake head bias.

16) The weeder rake system of claim 15, wherein said plurality of tines each comprise an outward projecting rod comprising perpendicularly bent tips.

17) The weeder rake system of claim 1 comprising a two-handed tool.

18) The weeder rake system of claim 1 comprising a one-handed tool.

19) A weeder rake system comprising;
a) at least one cylindrical rod comprising at least one proximal end and at least one distal end, said cylindrical rod comprising a handle, wherein said handle comprises finished wood;
b) at least one weed cutter head comprising a weather-durable and impact resistant plastic material, wherein said weed cutter head comprises an angle of approximately 70 degrees relative to said cylindrical rod, and wherein said weed cutter head comprises a friction-fitting cap that further comprises an inner volume to frictionally receive the proximal side of said handle wherein insertion results in air suction thereby forming a secure relationship between said handle and weeder handle inserter;
c) at least one cutting blade comprising steel, wherein said cutting blade comprises the at least one “C” shaped serrated edge;
d) at least one rake head comprising a fan-shaped profile, wherein said rake head comprises a plurality of raking tines, wherein said raking tines comprising perpendicularly bent tips that bias;
e) wherein said weed cutter head comprises a blade fastener for securing said at least one cutting blade to said weed cutter head;
f) wherein said weed cutter head and said cutting blade form together to create a trapezoid-shaped frame member comprising an open inner volume having at least one cutting edge for cutting weeds;
g) wherein said weed cutter head comprises a rod inserter such that said weed cutter head is securely attachable to said proximal end of said cylindrical rod;
h) wherein said rake head comprises a rod receiver such that said rake head is securely attachable to said distal end of said cylindrical rod; and
i) wherein said weeder rake system provides a multifunctional gardening tool for removing weeds from the ground via said weeder and for clearing weeds and other debris via said rake head.

20) A method of using a weeder rake to remove and clear weeds and debris comprising the steps of:
a) using weeder to cut and remove weeds;
b) turning the weeder rake upside down; and
c) using rake head to clear weeds and debris.
